(19) United States
(12) Patent Application Publication
(10) Pub. No.: US 2024/0258814 A1
(43) Pub. Date: Aug. 1, 2024

(54) DISTRIBUTIVE FAST CHARGING DEVICE AND CHARGING SYSTEM

(71) Applicant: DEXIN CORP., New Taipei City (TW)

(72) Inventors: Ho Lung LU, New Taipei City (TW); Kuo Wei LEE, New Taipei City (TW)

(73) Assignee: DEXIN CORP., New Taipei City (TW)

(21) Appl. No.: 18/123,225

(22) Filed: Mar. 17, 2023

(30) Foreign Application Priority Data
Feb. 1, 2023 (TW) 112103459

(51) Int. Cl. H02J 7/00

(52) U.S. Cl. CPC H02J 7/00712; H02J 2207/20; H02J 2207/30

(57) ABSTRACT

A distributive fast charging device, comprises a power input port, power output ports, a communication module, a power conversion module and a microcontroller. The communication module is configured to receive a setting instruction. The power conversion module is connected to the power input port and the power output ports, and is configured to convert initial power received from the power input module into converted power according to conversion ratios, and transfer the converted power to the power output ports. The microcontroller is connected to the communication module and the power conversion module, and is configured to adjust the conversion ratios according to the setting instruction.

### CROSS-REFERENCE TO RELATED APPLICATIONS

This non-provisional application claims priority under 35 U.S.C. § 119(a) on Patent Application No(s). 112103459 filed in Republic of China (R.O.C) on Feb. 1, 2023, the entire contents of which are hereby incorporated by reference.

### BACKGROUND

### 1. Technical Field

This disclosure relates to a charging device, especially relates with a distributive fast charging device.

### 2. Related Art

Recently, with devices such as smart phones becoming more and more common, the use of charging device has become more and more frequent in people' daily lives. Therefore, the technique of fast charging has gradually matured. The fast charging technique right now mainly achieves the effect of fast charging by increasing the charging power in a safe range.

The fast charging device right now may include many charging ports. However, the charging power of each charging port is fixed, which causes it to be not flexible when using.

### SUMMARY

Accordingly, this disclosure provides a distributive fast charging device.

According to an embodiment of this disclosure, the distributive fast charging device comprises a power input port, power output ports, a communication module, a power conversion module and a microcontroller. The communication module is configured to receive a setting instruction. The power conversion module is connected to the power input port and the power output ports, and is configured to be controlled to convert initial power received by the power input port into converted power according to conversion ratios, and transfer the converted power to the power output ports, respectively. The microcontroller is connected to the communication module and the power conversion module, and is configured to adjust the conversion ratios according to the setting instruction.

According to an embodiment of this disclosure, the charging system comprises the distributive fast charging device mentioned above and a mobile device. The mobile device is connected to the distributive fast charging device, and an application is installed in the mobile device, the application is configured to generate the setting instruction.

Through the structure above, the distributive fast charging device and charging system disclosed herein may receive a setting instruction from an external device (for example, a mobile device of an user) through the communication module, and adjust the output power of each charging power output port accordingly.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a distributive fast charging device according to an embodiment of the present disclosure;

FIG. 2 is a block diagram illustrating a distributive fast charging device according to another embodiment of the present disclosure;

FIG. 3 is a schematic diagram illustrating the exterior of the distributive fast charging device according to an embodiment of the present disclosure; and

FIG. 4 is a block diagram illustrating the charging system of an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

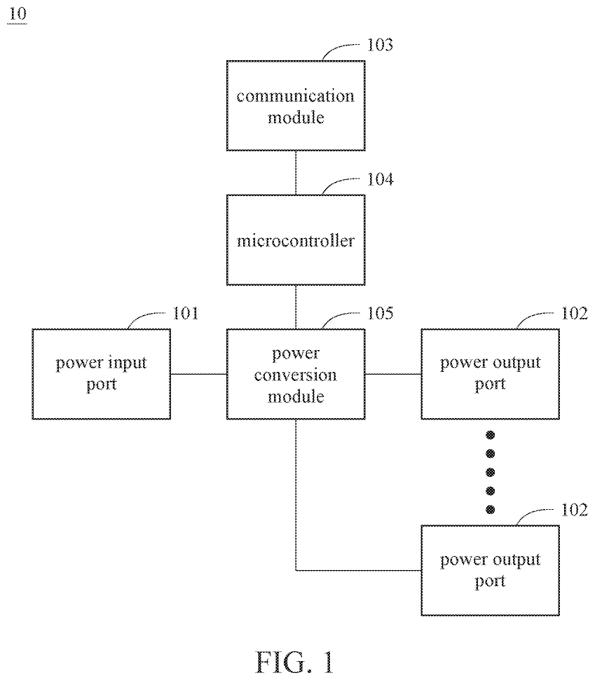

Please refer to FIG. 1 which is a block diagram of the distributive fast charging device according to an embodiment of the present disclosure. As shown in FIG. 1, the distributive fast charging device 10 comprises a power input port 101, power output ports 102, a communication module 103, a microcontroller 104, and a power conversion module 105, wherein the power input port 101 and the power output ports 102 are electrically connected to the power conversion module 105, and the communication module 103 and the power conversion module 105 are electrically connected the microcontroller 104.

The power input port 101 is configured to receive initial power. Particularly, the power input port 101 may be a plug or a power line adaptation port, which is configured to receive 110V or 220V power. The power output ports 102 are configured to output charging power. Particularly, each of the power output ports 102 may be type A or type C of universal serial bus (USB) connectors, and is configured to be electrically connected to an electronic device to be charged. The communication module 103 is, for example Bluetooth module, and is configured to receive a setting instruction from an external device (for example, a mobile device). Particularly, the communication module 103 may have techniques such as Bluetooth low energy (BLE) beacon and/or private application interface (API), and uses BLE generic attribute profile (BLE GATT) to receive the setting instruction and/or declare a broadcast function through the private application interface.

The microcontroller 104 is configured to adjust conversion ratios according to the setting instruction. The power conversion module 105, for example multiple DC-AC circuits or DC-DC circuits, which are configured to be controlled by the microcontroller 104 to convert the initial power received by the power input port 101 into converted power (which is the charging power mentioned above) and transfer the converted power to the power output ports 102, respectively. Particularly, the setting instruction includes power parameters and order parameters of the power output ports 102, the microcontroller 104 calculates the conversion ratios according to the power parameters and the initial power, or calculates the conversion ratios according to the order parameters and the initial power, wherein the power parameters and the power output ports 102 may have an one to one relationship, and the order parameters and the power output ports 102 may be in an one to one relationship. It should be noted that, the power providing performed by the microcontroller 104 and power conversion module 105 may support power delivery (PD) fast charge or quick charge (QC) fast charge.

In an implementation of the setting instruction including the power parameters, the power parameters may be included in a set of preset options corresponding to preset power (for example output power, output current, etc.) which the distributive fast charging device may output. Particularly, the microcontroller 104 may provide the preset options to the external device (for example, a mobile device) through the communication module 103 to for the user to choose the preset power of each of the power output ports 102 as the power parameters in the setting instruction. The microcontroller 104 may calculate a conversion ratio for each of the power output ports 102 according to the voltage or current of the initial power and the power parameters, and then the power conversion module 105 outputs power corresponding to the power parameters through each of the power output ports 102 according to the conversion ratios. More particularly, the power conversion module 105 may include conversion circuits and combination circuits of the conversion circuits to generate the preset power, wherein the operation of each conversion circuit or it's combination may be regarded as converting the initial power with a particular conversion ratio into charging power with particular power or current. After receiving the power parameters, the microcontroller 104 may calculate the conversion ratio corresponding to the power parameter of each of the power output ports 102, and controls a circuit connection relationship in the power conversion module 105 to connect certain conversion circuit (or certain combination of conversion circuits) to the corresponding power output port 102 to output the charging power satisfying the corresponding power parameter.

In an embodiment of the setting instruction including the order parameters, the order parameters may represent the charging priority of the power output ports 102. Particularly, the power output port 102 with the highest priority may correspond to the maximum power parameter, the rest of the power output ports 102 with higher priorities among the power output ports 102 may correspond to higher power parameters, the microcontroller 104 calculates the conversion ratio corresponding to each of the power output ports 102 according to the power parameter and the voltage or current of the initial power, and then the power conversion module 105 outputs the power corresponding to the power parameter through each of the power output ports 102 according to each of the conversion ratios, wherein the method of calculating the conversion ratio according to the power parameter and performing power conversion is the same as mentioned above, their description may not be repeated here.

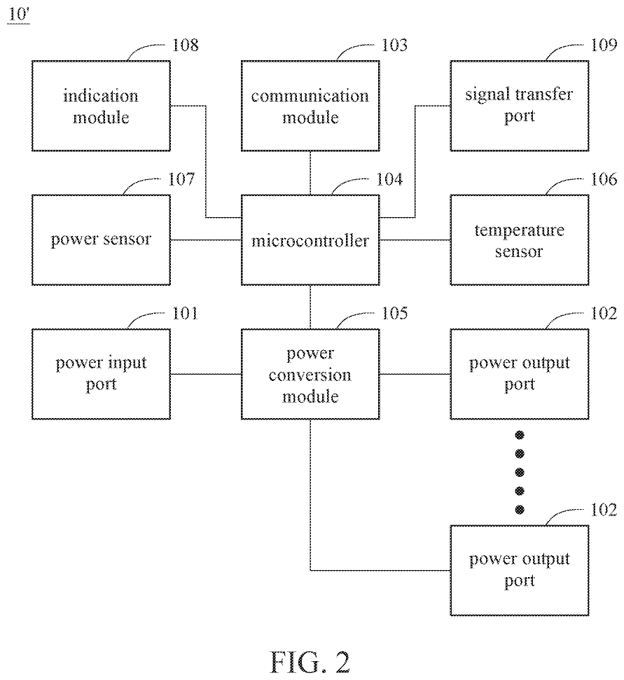

Please refer to FIG. 2. FIG. 2 is a block diagram illustrating the charging device according to yet another embodiment of the present disclosure. As shown in FIG. 2, the distributive fast charging device 10′ includes a power input port 101, power output ports 102, a communication module 103, a microcontroller 104, a power conversion module 105, a temperature sensor 106, a power sensor 107, an indication module 108 and a signal transfer port 109, wherein the connections and functions of the power input port 101, the power output ports 102, the communication module 103, the microcontroller 104, and the power conversion module 105 are mostly the same as the distributive fast charging device 10 illustrated in FIG. 1. Therefore, their description may not be repeated here. The temperature sensor 106, the power sensor 107, the indication module 108 and the signal transfer port 109 are connected with the microcontroller 104. It should be noted that, the temperature sensor 106, the power sensor 107, the sensor module 108 and the signal transfer port 109 mentioned above are optional parts. In other embodiments, the distributive fast charging device may include any one or more of these parts.

The temperature sensor 106 is configured to sense the temperature of the distributive fast charging device 10′ to generate a sensing result. Except the operation in the embodiment illustrated in FIG. 1, the microcontroller 104 may further send a state instruction through the communication module 103 with the sensing result to provide the temperature sensing result to an external device, and/or generate an indication instruction according to the sensing result to transfer to the indication module 108.

The power sensor 107 is configured to sense the power parameter (for example, voltage, current, or power) of each of the power output ports 102 of the distributive fast charging device 10′ to generate a sensing result. Except the operation in the embodiment illustrated in FIG. 1, the microcontroller 104 may further send a parameter instruction through the communication module 103 with the sensing result to provide the sensing result of the power parameters to an external device, and/or generate an indication instruction according to the sensing result to transfer to the indication module 108.

The indication module 108 may include one or more light emitting diodes, and is configured to indicate an emission state of the light emitting diodes according to the setting instruction and/or the indication instruction sent by the microcontroller 104, wherein in addition to the parameters associated with the conversion ratio mentioned above, the setting instruction may further include light emission control parameters to control the light emitting diodes, and the indication instruction may be generated according to the sensing result of the temperature sensor 106 and/or power sensor 107. Particularly, the indication module 108 may include multiple light emitting diodes which are independently disposed and may emit different colors (for example red, green, blue) of light according the setting instruction and/or the indication instruction. Alternatively, the indication module 108 may be a light emitting diode display, and may display the inner temperature of the distributive fast charging device 10′ and/or the charging mode of the distributive fast charging device 10′ according to the indication instruction. Additionally, the microcontroller 104 may also set the display pattern, the light emitting timing control, and the display of the distribution priority.

The signal transfer port 109 is, for example an universal serial bus (USB) connection port, and is connected to the microcontroller 104, and is configured to receive another setting instruction from an external device (for example, a personal computer), the another setting instruction may include power parameters or order parameters of the power output ports 102, the microcontroller 104 may calculate the conversion ratios according to the power parameters and the initial power or calculate the conversion ratios according to the order parameters and the initial power, wherein the setting and method of calculation of the power parameter, the order parameter and the conversion ratios may be the same as the method of the embodiment illustrated in FIG. 1, which may not be repeated herein. Additionally, the communication module 103 or the signal transfer port 109 may be further configured to receive an update setting, and send the update setting to the microcontroller 104, and the microcontroller 104 is further configured to update the firmware according to the update setting.

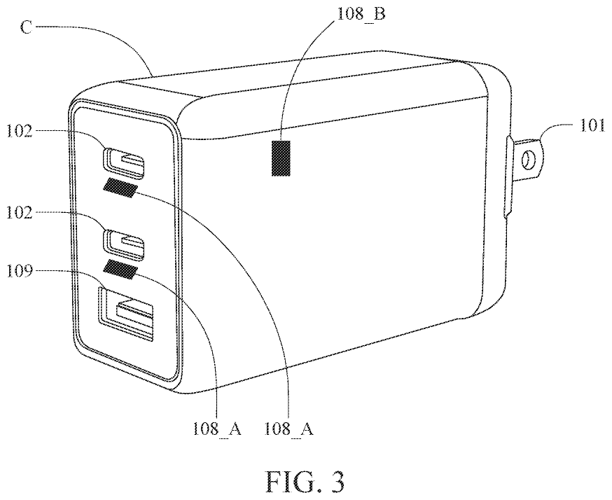

Please refer to FIG. 2 and FIG. 3. FIG. 3 is a schematic diagram illustrating the exterior of the distributive fast charging device according to an embodiment of the present disclosure. Hereinbelow, the exterior illustrated in FIG. 3 may be used as an example to describe some parts of the distributive fast charging device 10′ illustrated in FIG. 2. The distributive fast charging device illustrated in FIG. 3 may include all the parts shown in FIG. 2, wherein the communication module 103, the microcontroller 104, the power conversion module 105, the temperature sensor 106 and the power sensor 107 may be disposed on one or more circuit boards inside the case C. The indication module 108 may include a first set of light emitting diodes 108_A and a second set of light emitting diodes 108_B.

As shown in FIG. 3, the power input port 101 (for example, a plug, but the present disclosure is not limited thereto) is configured to receive the initial power, and output power through the power output ports 102 (for example, Type-C connector, but the present disclosure is not limited thereto) after the conversion of the power conversion module 105. The temperature sensor 106 senses the temperature inside the charging device, and sends the sensing result to the microcontroller 104. If the sensing results meets a preset condition (for example, higher than a preset temperature), the microcontroller 104 may instruct the indication module 108 to present a state, for example, to let the first set of light emitting diodes 108_A in the indication module 108 to emit red light. The power sensor 107 senses the power parameters of the power output ports 102 and the microcontroller 104 instructs the indication module 108 to present a state, for example, when there is current flowing through any one of the power output ports 102, the corresponding light emitting diode in the first set of light emitting diodes 108_A in the indication module 108 may emit light. The signal transfer port 109 may connect an external device (for example, computer) to obtain the update file of the firmware of the charging device or the setting instruction. However, the above description is just an implementation of the present disclosure, the relationship between multiple modules and the form of the indication module of the present disclosure is not limited by the particular details thereof.

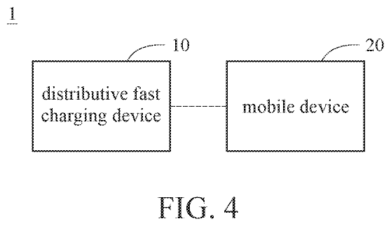

Please refer to FIG. 4, which is a block diagram illustrating a charging system according to an embodiment of the present disclosure. As shown in FIG. 4, the charging system 1 includes the distributive fast charging device 10 and a mobile device 20 where an application is installed, the application is configured to generate the setting instruction. Particularly, the application may connect with the communication module of the distributive fast charging device 10 through the BLE Generic Attribute Profile (BLE GATT) and/or through the private API in the communication module 103, and may dynamically control the power parameters of each of the power output ports and/or control the light emission state of the light emitting diodes in the indication module, and obtain all the states of the distributive fast charging device 10 in real time by obtaining the sensing result of the power sensor and/or the temperature sensor by receiving the parameter instruction and/or the state instruction. Although FIG. 4 illustrates the distributive fast charging device 10 as an example, the distributive fast charging device 10′ illustrated in FIG. 2 may also be applicable to the charging device 1 illustrated in FIG. 4.

Through the structure above, the distributive fast charging device and charging system disclosed herein may receive a setting instruction from an external device (for example, a mobile device of a user) through the communication module, and adjust the output power of each charging power output port accordingly.

What is claimed is:

1. A distributive fast charging device, comprising:
a power input port;
a plurality of power output ports;
a communication module configured to receive a setting instruction;
a power conversion module connected to the power input port and the plurality of power output ports, and configured to be controlled to convert initial power received by the power input port into converted power according to a plurality of conversion ratios and transfer the converted power to the plurality of power output ports, respectively; and
a microcontroller connected to the communication module and the power conversion module, and configured to adjust the plurality of conversion ratios according to the setting instruction.

2. The distributive fast charging device according to claim 1, wherein the setting instruction comprises a plurality of power parameters or a plurality of order parameters of the plurality of power output ports, and the microcontroller calculates the plurality of conversion ratios according to the plurality of power parameters and the initial power, or calculates the plurality of conversion ratios according to the plurality of order parameters and the initial power.

3. The distributive fast charging device according to claim 1, further comprising:
a temperature sensor connected to the microcontroller, and configured to sense a temperature of the distributive fast charging device to generate a sensing result;
wherein the microcontroller is further configured to send a state instruction through the communication module with the sensing result.

4. The distributive fast charging device according to claim 1, further comprising:
a temperature sensor connected to the microcontroller, and configured to sense a temperature of the distributive fast charging device to generate a sensing result; and
an indication module connected to the microcontroller, and is configured to receive an indication instruction from the microcontroller to indicate a state, wherein the indication instruction is generated by the microcontroller according to the sensing result.

5. The distributive fast charging device according to claim 1, further comprising:
a power sensor connected to the microcontroller, and configured to sense a plurality of power parameters of the plurality of power output ports to generate a sensing result;
wherein the microcontroller is further configured to send a parameter instruction through the communication module with the sensing result.

6. The distributive fast charging device according to claim 1, further comprising:
a power sensor connected to the microcontroller, and configured to sense a plurality of power parameters of the plurality of power output ports to generate a sensing result; and
an indication module connected to the microcontroller, and configured receive an indication instruction to indicate a state, wherein the indication instruction is generated by the microcontroller according to the sensing result.

7. The distributive fast charging device according to claim 1, further comprising:
an indication module connected to the microcontroller, the indication module comprising light emitting diodes;
wherein the setting instruction comprises light emission parameters, and the microcontroller instructs a light emission state of the light diodes of the indication module according to the setting instruction.

8. The distributive fast charging device according to claim 1, further comprising a signal transfer port connected to the microcontroller, and configured to receive another setting instruction from an external device, the another setting instruction comprising a plurality of second power parameters or a plurality of second order parameters of the plurality of power output ports, with the microcontroller further configured to calculate the plurality of conversion ratios according to the plurality of second power parameters and the initial power or calculate the plurality of conversion ratios according to the plurality of second order parameters and the initial power.

9. The distributive fast charging device according to claim 1, wherein the communication module or a signal transfer port is further configured to receive an update setting, and transfer the update setting to the microcontroller, and the microcontroller is further configured to update a firmware according to the update setting.

10. The distributive fast charging device according to claim 8, wherein the communication module or the signal transfer port is further configured to receive an update setting, and transfer the update setting to the microcontroller, and the microcontroller is further configured to update a firmware according to the update setting.

11. A charging system, comprising:
the distributive fast charging device according to claim 1; and
a mobile device connected to the distributive fast charging device, wherein an application is installed in the mobile device, and the application is configured to generate the setting instruction.

12. A charging system, comprising:
the distributive fast charging device according to claim 2; and
a mobile device connected to the distributive fast charging device, wherein an application is installed in the mobile device, and the application is configured to generate the setting instruction.

13. A charging system, comprising:
the distributive fast charging device according to claim 3; and
a mobile device connected to the distributive fast charging device, wherein an application is installed in the mobile device, and the application is configured to generate the setting instruction.

14. A charging system, comprising:
the distributive fast charging device according to claim 4; and
a mobile device connected to the distributive fast charging device, wherein an application is installed in the mobile device, and the application is configured to generate the setting instruction.

15. A charging system, comprising:
the distributive fast charging device according to claim 5; and
a mobile device connected to the distributive fast charging device, wherein an application is installed in the mobile device, and the application is configured to generate the setting instruction.

16. A charging system, comprising:
the distributive fast charging device according to claim 6; and
a mobile device connected to the distributive fast charging device, wherein an application is installed in the mobile device, and the application is configured to generate the setting instruction.

17. A charging system, comprising:
the distributive fast charging device according to claim 7; and
a mobile device connected to the distributive fast charging device, wherein an application is installed in the mobile device, and the application is configured to generate the setting instruction.

18. A charging system, comprising:
the distributive fast charging device according to claim 8; and
a mobile device connected to the distributive fast charging device, wherein an application is installed in the mobile device, and the application is configured to generate the setting instruction.

19. A charging system, comprising:
the distributive fast charging device according to claim 9; and
a mobile device connected to the distributive fast charging device, wherein an application is installed in the mobile device, and the application is configured to generate the setting instruction.
